(19) United States
(12) Patent Application Publication
(10) Pub. No.: US 2008/0084285 A1
(43) Pub. Date: Apr. 10, 2008

(54) SYSTEM AND METHOD FOR AUTONOMIC DETECTION OF TIRE TREAD WEAR

(76) Inventors: Kulvir Singh Bhogal, Fort Worth, TX (US); Peter George Finn, Brampton (CA); Rick Allen Hamilton, Charlottesville, VA (US); James W. Seaman, Falls Church, VA (US)

Correspondence Address: IBM CORP (YA);C/O YEE & ASSOCIATES PC, P.O. BOX 802333, DALLAS, TX, 75380, US

(21) Appl. No.: 11/539,031

(22) Filed: Oct. 5, 2006

(51) Int. Cl. B60Q 1/00

(52) U.S. Cl. 340/438; 340/505

(57) ABSTRACT

A system and method for using Radio Frequency IDentification (RFID) tags to monitor tire tread wear in vehicles. A Radio Frequency IDentification chip is embedded in a tread of a tire at a radial depth of allowable tire tread wear specified by a manufacturer of the tire. Responsive to embedding the Radio Frequency IDentification chip in the tread, the presence of the Radio Frequency IDentification chip may be detected by polling the Radio Frequency IDentification chip for a signal. If the Radio Frequency IDentification reader fails to detect the signal of the Radio Frequency IDentification chip, a notification that the tire should be replaced is provided.

### BACKGROUND OF THE INVENTION

1. Field of the Invention

The present invention relates generally to a system and method for using Radio Frequency IDentification (RFID) tags to monitor tire tread wear in vehicles.

2. Description of the Related Art

Use of Radio Frequency IDentification (RFID) technology is exploding as industry finds new ways to exploit this technology. RFID chips send a constant (unique) signal that can be read by RFID receiving equipment and then processed to enable/allow various activity. There are two kinds of RFID chips—“passive” and “active”. Active chips have an associated power source (battery) that boosts the RFID signal so it can be recognized by receiving equipment many feet away. A familiar use of active RFID chips is the various intelligent road/bridge toll payment devices in wide use today. As a vehicle with such a device mounted on the windshield approaches the toll booth, the RFID signal is detected from the toll tag inside the vehicle and processed by the receiver proximately located at the toll booth. Upon receipt of the RFID signal, the receiver incorporates the toll fees to a customer account, which is typically charged to an associated credit card, and then provides a clearance indication (light, sound, physical barrier being removed) to the driver so that the driver may proceed, confident that the toll has been paid. Passive RFID chips send a signal with very low power so they must be very close (inches to not less than ˜10 meters, depending upon design characteristics) to the receiving equipment to be read.

One familiar example of a passive RFID is the ExxonMobil® Speedpass® device that allows one to purchase gasoline (or other goods) by swiping the Speedpass device at the gas pump or point-of-sale terminal. The unique radio frequency identifies an owner with an associated credit card that is used to complete the transaction. RFID usage is increasing dramatically as organizations come up with new applications for the technology. Inventory management and pallet tracking are ideal and are being pursued vigorously by retailers such as Wal-Mart®.

### SUMMARY OF THE INVENTION

The illustrative embodiments provide a system and method for using Radio Frequency IDentification (RFID) tags to monitor tire tread wear in vehicles. A Radio Frequency IDentification chip is embedded in a tread of a tire at a radial depth of allowable tire tread wear specified by a manufacturer of the tire. Responsive to embedding the Radio Frequency IDentification chip in the tread, the presence of the Radio Frequency IDentification chip may be detected by polling the Radio Frequency IDentification chip for a signal. If the Radio Frequency IDentification reader fails to detect the signal of the Radio Frequency IDentification chip, a notification that the tire should be replaced is provided.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system with which the illustrative embodiments may be implemented;

FIG. 2 is a high-level block diagram of components with which the illustrative embodiments may be implemented;

FIG. 3 is a pictorial diagram illustrating a portion of a tire tread containing embedded RFID chips;

FIG. 4A is a cross sectional diagram illustrating an exemplary placement of an RFID chip within a new tire tread;

FIG. 4B is a cross sectional diagram illustrating a destroyed RFID chip in a worn tire tread;

FIG. 4C is a cross sectional diagram illustrating multiple layers of RFID chips embedded within a new tire tread; and

FIG. 5 is a flowchart of a process for using RFID chips to monitor tire tread wear in vehicles.

### DETAILED DESCRIPTION OF THE PREFERRED EMBODIMENT

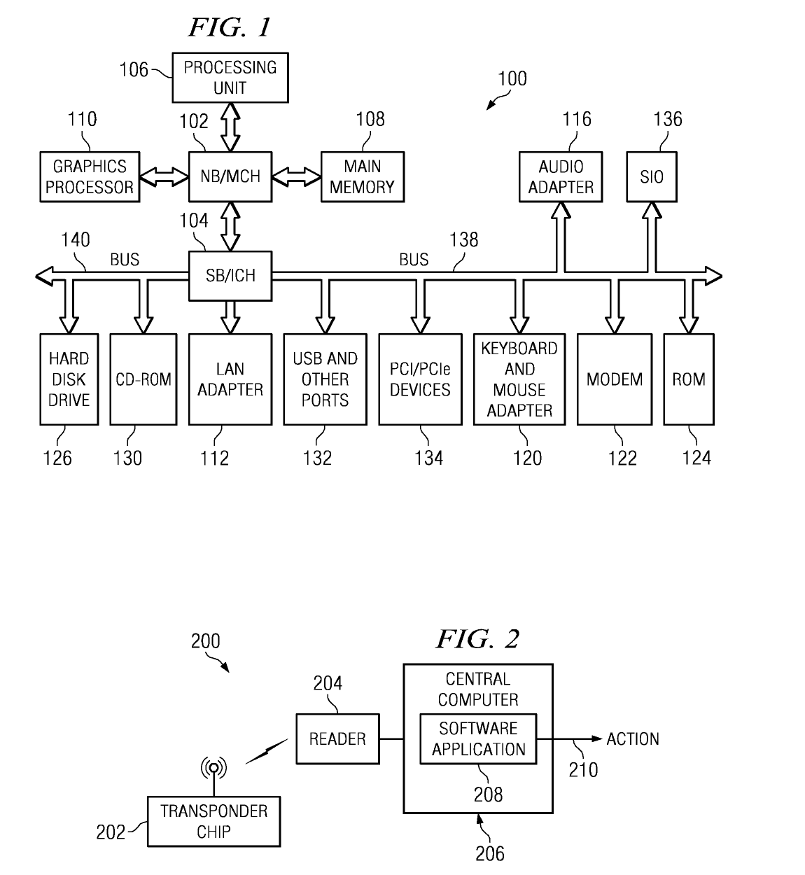

With reference now to FIG. 1, a block diagram of a data processing system is shown with which the illustrative embodiments may be implemented. Data processing system 100 is an example of a computer in which computer usable code or instructions implementing the processes for the illustrative embodiments may be located.

In the depicted example, data processing system 100 employs a hub architecture including north bridge and memory controller hub (NB/MCH) 102 and south bridge and input/output (I/O) controller hub (SB/ICH) 104. Processing unit 106, main memory 108, and graphics processor 110 are connected to NB/MCH 102. Graphics processor 110 may be connected to NB/MCH 102 through an accelerated graphics port (AGP).

In the depicted example, local area network (LAN) adapter 112 connects to SB/ICH 104. Audio adapter 116, keyboard and mouse adapter 120, modem 122, read only memory (ROM) 124, hard disk drive (HDD) 126, CD-ROM drive 130, universal serial bus (USB) ports and other communication ports 132, and PCI/PCIe devices 134 connect to SB/ICH 104 through bus 138 and bus 140. PCI/PCIe devices may include, for example, Ethernet adapters, add-in cards, and PC cards for notebook computers. PCI uses a card bus controller, while PCIe does not. ROM 124 may be, for example, a flash binary input/output system (BIOS).

HDD 126 and CD-ROM drive 130 connect to SB/ICH 104 through bus 140. HDD 126 and CD-ROM drive 130 may use, for example, an integrated drive electronics (IDE) or serial advanced technology attachment (SATA) interface. Super I/O (SIO) device 136 may be connected to SB/ICH 104.

An operating system runs on processing unit 106 and coordinates and provides control of various components within data processing system 100 in FIG. 1. As a client, the operating system may be a commercially available operating system such as Microsoft®Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 100 (Java is a trademark of Sun Microsystems, Inc. in the United States, other countries, or both).

As a server, data processing system 100 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 100 may be a symmetric multiprocessor (SMP) system including a plurality of processors in processing unit 106. Alternatively, a single processor system may be employed.

Instructions for the operating system, the object-oriented programming system, and applications or programs are located on storage devices, such as HDD 126, and may be loaded into main memory 108 for execution by processing unit 106. The processes for the illustrative embodiments are performed by processing unit 106 using computer usable program code, which may be located in a memory such as, for example, main memory 108, ROM 124, or in one or more peripheral devices 126 and 130.

Those of ordinary skill in the art will appreciate that the hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. Also, the processes of the illustrative embodiments may be applied to a multiprocessor data processing system.

In some illustrative examples, data processing system 100 may be a personal digital assistant (PDA), which is configured with flash memory to provide non-volatile memory for storing operating system files and/or user-generated data.

A bus system may be comprised of one or more buses, such as bus 138 or bus 140. Of course, the bus system may be implemented using any type of communication fabric or architecture that provides for a transfer of data between different components or devices attached to the fabric or architecture. A communication unit may include one or more devices used to transmit and receive data, such as modem 122 or network adapter 112. A memory may be, for example, main memory 108, ROM 124, or a cache such as found in NB/MCH 102. The depicted examples in FIG. 1 and above-described examples are not meant to imply architectural limitations. For example, data processing system 100 also may be a tablet computer, laptop computer, or telephone device in addition to taking the form of a PDA.

The illustrative embodiments provide a method for using Radio Frequency IDentification (RFID) tags to monitor tire tread wear in vehicles such as automobiles, aircraft, trailers, and other such vehicles where tire tread wears over time. Monitoring the amount of tread on a vehicle's tire is critical to ensuring that vehicle's safety. In the current art, there is presently no way of notifying a vehicle's driver that the tire and/or its tread should be replaced. Only expert judgment is currently used to determine if a tire tread needs replacing, and such decisions are often dependent on the type of tire and the conditions for which it was created. Tire tread wear is a major safety concern, particularly when driving in difficult weather conditions such as snow, ice, and rain. The tire tread monitoring system in the illustrative embodiments automates the manual process of determining whether tire tread is worn, resulting in both time savings and safety enhancements.

In particular, the tire tread monitoring system notifies the driver of the vehicle when the tire should be replaced in accordance with the manufacturer's specifications. The tire tread monitoring system uses one or more RFID Chips embedded into the tire tread. RFID is a generic term for wireless technologies that use radio waves to automatically identify people or objects. In particular, RFID employs tags, or transponders, which store information to be transmitted wirelessly in an automated fashion to specialized RFID readers, or interrogators. There are several methods of identification, but the most common is to store a “serial number” that identifies a person or object, and perhaps other information, within a tag comprising a microchip that is attached to an antenna. The “serial number” may be used to specify the unique, numerical identifier of the entity, thereby allowing a user device to distinguish one entity from another. For example, when an entity transmits a signal comprising its unique identifier and other information, an RFID-enabled mobile computing device may receive the signal and identify the entity.

The tire tread monitoring system detects dangerous tire tread conditions through the use of “eroding” RFID tags. For instance, RFID tags are embedded within the tread of a tire. These tags are used to signal an RFID reader, preferably located within the vehicle, that the RFID tags are present in the tread. As the tread of the tire wears down over time, the RFID tags embedded in the tread will eventually become exposed to the road, and thus will be dislodged from the tread or destroyed. When an RFID chip contained within the tread of a tire can no longer be detected by the reader, the loss of the associated signal may be used to provide a warning notification to the driver or directly to the vehicle that the condition of the tire tread is below an acceptable level, thereby permitting appropriate actions to be taken.

While existing methods of monitoring tire conditions employ additional sensors incorporated into the tire and use RFID to relay tire information obtained from the sensors back to the driver, the tire tread monitoring system in the illustrative embodiments uses the absence of an RFID signal to inform a driver of dangerous tire tread conditions. The tire tread monitoring system described herein is a low cost solution, as the RFID tag is not required to have any additional sensors. The tire tread monitoring system may also use a passive RFID tag or an active RFID tag. When the RFID reader no longer receives signals from the embedded RFID chip, it is time to replace the tire.

Turning now to FIG. 2, a high-level block diagram is depicted with which the illustrative embodiments may be implemented. In this illustrative example, tire tread monitoring system 200 comprises transponder chip 202, reader 204, and central computer 206. Central computer 206 is an example of a computing system, such as data processing system 100 described in FIG. 1. Transponder chip 202, or tag, is embedded within the tread of a tire and comprises a microchip that is attached to an antenna. Transponder chip 202 is a wireless communications device capable of receiving and automatically responding to incoming signals. Transponder chip 202 stores information to be transmitted wirelessly in an automated fashion to specialized receivers, such as reader 204. An example of a reader is a radio frequency receiver, which uses an antenna to receive transmitted radio signals. Transponder chip 202 may be an active or passive transponder. For example, a passive transponder will send no signals to a reader until the transponder itself receives an incoming signal or it is placed within, for example, a magnetic field. If placed within a magnetic field, the magnetic field may cause a coil within the chip to produce an electric current to power the transponder and allow the transponder to transmit a signal. In this particular example, transponder chip 202 is a RFID device, which uses radio waves to automatically identify people or components. When a component containing an RFID tag transmits a radio signal comprising its unique identifier and other information, an RFID-enabled reader may receive the signal.

Transponder chip 202 is embedded within a tire tread, and reader 204 may be located within the vehicle containing the tire tread. Reader 204 continually or periodically polls each embedded RFID chip in the tire to determine if the RFID chips can be detected. Upon receiving an incoming signal at reader 204 from transponder chip 202, reader 204 may identify the transponder chip 202 sending the signal. Receipt of a signal indicates that transponder chip 202 is still active and embedded within the tire tread of the vehicle, and thus the level of tire tread wear is determined to be within acceptable limits.

As the tire tread wears down to the point of the embedded RFID chip, the chip will be destroyed by contact with the road. If reader 204 can no longer detect a signal from transponder chip 202 within a set time period, reader 204 informs software application 208 in the vehicle's central computer 206 of the absence of the transponder signal. Although this illustrative example shows software application 208 which provides the notification of tire tread loss as part of the vehicle's central computer 206, software application 208 may be directly tied to the reader 204.

In response to the absence of the transponder signal which indicates that the tire tread has been worn down to a particular threshold level, software application 208 initiates a set of actions 210. These actions may include providing a visual or audible notification to the driver. For example, notifications to the driver may include using an audible alert such as buzzer or a voice system which indicates the tire that needs to be replaced, or a visual alert such as warning light, or a cathode ray, plasma or liquid crystal display. Other notification actions may include logging an error condition within the vehicle's central computer, notifying an appropriate service facility, or in the case of fleet vehicles, notifying a central dispatch/control facility. The type of notification provided may also vary in levels of severity, such that a moderate notification warning may be provided to the driver when moderate tire tread wear is detected, such as when an RFID chip placed at one depth in the tire tread, and a severe notification warning may be provided to the driver when severe tire tread wear is detected, such as when an RFID chip placed at a lower depth in the tire tread. Thus, software application 208 may direct the action to be taken in response to the absence of a signal from transponder chip 202. Additionally, if the RFID chips are embedded in the tire tread in multiple layers, when signal has been lost at the deepest layer indicating severe and potentially dangerous tread loss, software application 208 may take a secondary action, such as disabling the starter motor of the vehicle or activating a speed regulator in the vehicle to control the maximum speed of the vehicle.

FIG. 3 is a pictorial diagram illustrating a portion of a tire tread containing embedded RFID chips. Tire tread 300 is shown to include three RFID chips 302, 304, and 306 embedded within, although any number of RFID chips may be embedded within the tire tread. Any known method of fixing RFID chips to tire tread may be used to embed the RFID chips into the grooves in the tread. RFID chips 302, 304, and 306 may be embedded at the manufacturer's recommended tread depth specifications for the specific tire used.

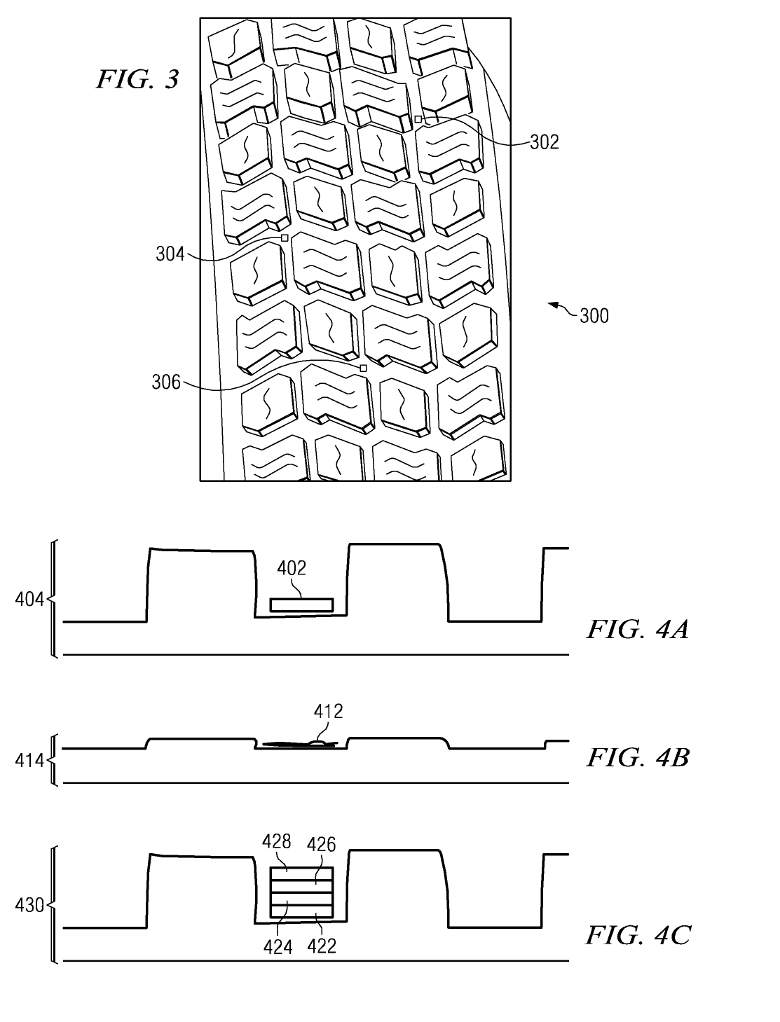

FIG. 4A is a cross sectional diagram illustrating an exemplary placement of an RFID chip within a new tire tread. Within FIG. 4A, a single RFID chip 402 is shown embedded in tire tread 404. It should be noted that RFID chip 402 may be placed at any depth in tire tread 404. In one embodiment, RFID chip 402 may be embedded at a radial depth in tire tread 404 which corresponds to a point where the manufacturer has decided the level tread wear has exceeded specifications for safe travel.

When the tire tread wears down to the point of RFID chip 402, the chip will be destroyed by contact with the road, and the chip will no longer send a signal to the RFID reader, as shown by destroyed RFID chip 412 and worn tire tread 414 in FIG. 4B. Since the reader can no longer detect RFID chip 402 as shown in FIG. 4A, the driver may be notified that tire tread is worn beyond the manufacturer's recommended tread depth. As previously mentioned, multiple RFID chips may be embedded within the tread to provide a quorum of active signals to the reader in order to indicate safe tread depth at multiple points around the tire.

Additionally, multiple layers of RFID chips may be embedded into the tire tread, as shown in FIG. 4C. RFID chips 422, 424, 426, and 428 are embedded in layers within tire tread 430. RFID chips 422-428 are embedded at various depths within tire tread 430 to allow for detecting the absence of an RFID signal for the various chips. For instance, if the reader no longer can detect a signal from RFID chip 426, a moderate warning notification may be provided to the driver to inform the driver that the tread wear is below a specific threshold. If the reader no longer can detect a signal from RFID chip 424, a severe warning notification may be provided to the driver to indicate that action to replace the tire is required for safety reasons.

Furthermore, actions other than notifications may be taken when a reader can no longer detect an RFID signal. For example, when the RFID signal is lost from a chip embedded at the deepest layer in the tire tread, such as RFID chip 422, the absence of the signal may indicate severe and potentially dangerous tread loss. The action taken in response to the loss of the signal from RFID 422 may include a secondary action, such as disabling the vehicle to prevent the vehicle engine from starting.

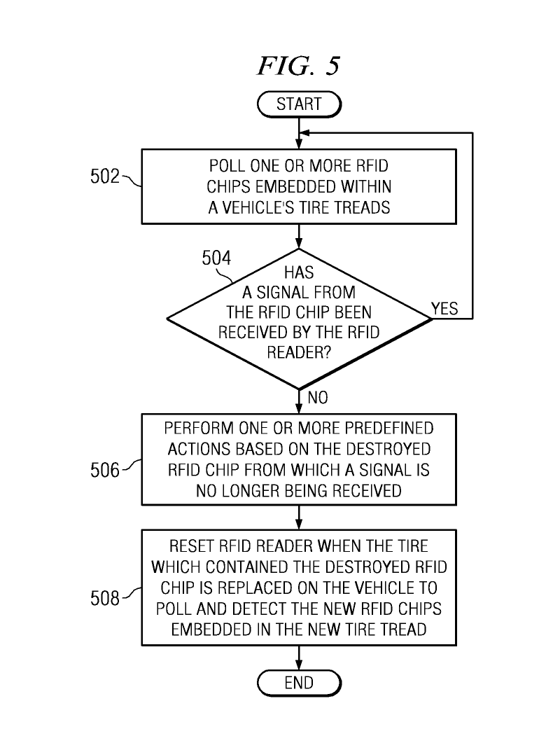

FIG. 5 is a flowchart of a process for using RFID chips to monitor tire tread wear in vehicles. The process described in FIG. 5 may be implemented using components illustrated in tire tread monitoring system 200 in FIG. 2. The process begins with an RFID reader, which is located within a vehicle, polling one or more RFID chips embedded within the vehicle's tire treads (step 502). The RFID reader may poll the RFID chips in a continuous or periodic manner. In response to polling an RFID chip, the RFID reader determines if a signal from the RFID chip has been received (step 504). If a signal is received from the RFID chip (‘yes’ output of step 504), the process loops back to step 502.

The lack of a detectable signal from the RFID chip indicates that the RFID chip has been destroyed, and thus the tire tread has worn beyond a particular threshold level. If no signal is received from the RFID chip (‘no’ output of step 504), the reader instructs the software application to perform one or more predefined actions based on the destroyed RFID chip from which a signal is no longer being received (step 506). Responsive to the reader failing to detect the RFID chip embedded in the tire, the software application may provide a visual or audible notification to the driver. This notification may comprise an action to be taken by the driver based on the level of severity of the wear on the tire tread, such as replacing the worn tire. Other notifications may include logging of an error condition within the vehicle's central computer, notifying an appropriate service facility, or notifying a central dispatch/control facility in the case of fleet vehicles. The predefined actions may also include actions performed by the software application based on the severity of the tread wear, such as disabling the vehicle or activating a speed regulator in the vehicle to control the maximum speed of the vehicle if the loss of signal from the RFID chip indicates that the tire tread is worn beyond a safe level.

When the tire which contained the destroyed RFID chip is replaced on the vehicle, the RFID reader is reset to poll and detect the new RFID chips embedded in the new tire tread (step 508), with the process terminating thereafter.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for monitoring tire tread wear on a vehicle, the computer implemented method comprising:
embedding a Radio Frequency IDentification chip in a tread of a tire at a radial depth of allowable tire tread wear specified by a manufacturer of the tire;
responsive to embedding the Radio Frequency IDentification chip in the tread, detecting a presence of the Radio Frequency IDentification chip by polling the Radio Frequency IDentification chip for a signal; and
responsive to a failure of a Radio Frequency IDentification reader to detect the signal of the Radio Frequency IDentification chip, providing a notification recommending that the tire be replaced.

2. The computer implemented method of claim 1, wherein the notification includes one of an visual or audible alert to a driver of the vehicle, a log of an error condition to a computer of the vehicle, an alert to a service facility, or an alert to a central dispatch or control facility.

3. The computer implemented method of claim 1, wherein providing a notification further comprises performing at least one of an action to disable the starter motor of the vehicle or an action to activate a speed regulator in the vehicle to control the maximum speed of the vehicle.

4. The computer implemented method of claim 1, further comprising:
responsive to replacement of the tire with a new tire, resetting the Radio Frequency IDentification reader to detect a new Radio Frequency IDentification chip embedded within the new tire.

5. The computer implemented method of claim 1, wherein the tread comprises multiple Radio Frequency IDentification chips embedded at various depths within the tread.

6. The computer implemented method of claim 5, wherein the various depths at which the Radio Frequency IDentification chips are embedded determines a type or severity of the notifications provided.

7. A system for monitoring tire tread wear on a vehicle, the system comprising:
a tire;
a Radio Frequency IDentification chip embedded within a tread of the tire, wherein the Radio Frequency IDentification chip is embedded at a radial depth of allowable tire tread wear specified by a manufacturer of the tire; and
a Radio Frequency IDentification reader, wherein the Radio Frequency IDentification reader detects a presence of the Radio Frequency IDentification chip by polling the Radio Frequency IDentification chip for a signal, and wherein the Radio Frequency IDentification reader provides a notification recommending that the tire be replaced in response to a failure of the Radio Frequency IDentification reader to detect the signal of the Radio Frequency IDentification chip.
